(19) United States
(12) Patent Application Publication
(10) Pub. No.: US 2025/0123921 A1
(43) Pub. Date: Apr. 17, 2025

(54) LOW LATENCY MEMORY CONTROLLER MULTIBIT ECC (ERROR CORRECTION CODE) DECODER

(71) Applicant: Intel Corporation, Santa Clara, CA (US)

(72) Inventor: Zion S. KWOK, Burnaby (CA)

(21) Appl. No.: 18/999,443

(22) Filed: Dec. 23, 2024

(51) Int. Cl. G06F 11/10

(52) U.S. Cl. CPC G06F 11/1044

(57) ABSTRACT

A memory subsystem performs error correction through erasure decoding instead of ECC (error correction code) polynomial computation. An error correction module of the memory controller receives a data word and calculates a syndrome using the data word. The error correction module generates multiple correctable error pattern candidates for bounded fault regions based on erasure decoding. The error correction module selects one correctable error pattern candidate to apply error correction.

### FIELD

Descriptions are generally related to memory systems, and more particular descriptions are related to host-based error correction.

### BACKGROUND

Computer system memory is subject to errors, either from transient errors or hardware failures. ECC (error correction code, or alternatively, error checking and correction) can correct for errors in the data read from memory to the host system. The host system applies error correction to the received data (e.g., the codeword).

Depending on the error correction algorithm applied, the system can correct 2-bit errors in a codeword. A 2-bit error can be referred to as a 2-symbol error, referring to the identification of the “symbols” in the decoding operation, which is used to identify an error to correct. There is fixed-latency correction, which has a fixed latency per stage of the decoding, which has an undesirable latency penalty for correction. Variable latency decoding increases design complexity and hardware cost.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a system that performs error correction with erasure decoding.

FIG. 2 is a block diagram of an example of a sequence for error correction.

FIG. 3 is a block diagram of an example of an error correction sequence with a reduced overhead.

FIG. 4 is a block diagram of an example of erasure decoding by bounded region.

FIGS. 5A-5D are block diagrams of an example of erasure decoding.

FIGS. 6A-6B are block diagrams of examples of an error decoding system.

FIG. 7 is a flow diagram of an example of process for error correction.

FIG. 8 is a block diagram of an example of a memory subsystem in which erasure decoding error correction can be implemented.

FIGS. 9A-9B are block diagrams of an example of a CAMM system in which erasure decoding error correction can be implemented.

FIG. 10 is a block diagram of an example of a computing system in which erasure decoding error correction can be implemented.

FIG. 11 is a block diagram of an example of a multi-node network in which erasure decoding error correction can be implemented.

Descriptions of certain details and implementations follow, including non-limiting descriptions of the figures, which may depict some or all examples, and well as other potential implementations.

### DETAILED DESCRIPTION

As described herein, a system performs error correction through erasure decoding instead of ECC (error correction code) polynomial computation. An error correction module of the memory controller receives a data word and calculates a syndrome using the data word. The error correction module generates multiple correction candidates for bounded fault regions based on erasure decoding. The error correction module selects one correction candidate to apply error correction.

Reference herein to a correction candidate refers to a candidate for performing error correction. The correction candidate can alternatively be referred to as a correctable error pattern candidate, referring to an error pattern that can be corrected through the application of error correction. The correctable error pattern candidate refers to an error pattern for a group of bits in an IO (input/output) interface.

Typically, Reed-Solomon decoding involves calculating a syndrome, generating a polynomial, and then solving the polynomial to identify the error locations. The system can then correct the identified errors. As described herein, the use of erasure decoding enables the system to identify the error location without performing polynomial calculations. Thus, the system can perform error correction without multiplication and division, which speeds up the error correction.

As described herein, a system uses a different pattern to carry out error correction. The system can still calculate the syndrome, followed by erasure decoding to generate multiple candidates of corrected data, and then choose one candidate as the corrected data. The erasure decoding operations involves simple operations that can be performed in parallel, and can be performed very quickly. Once the system generates the candidates, it selects the best candidate through erasure decoding.

By eliminating the polynomial computations and performing error decoding with parallel operations, the system can perform 2-bit error correction with latency that is similar to SBE (single bit error) correction. Depending on the system configuration, the system can use the erasure decoding to correct more than 2 bits, such as 4 bits.

In one example, the system treats the memory IO (input/output) as bounded fault regions. Based on statistical analysis, if a memory device experiences a failure on one DQ (data interface or data pin), a second failure for the memory device is most likely within a group of DQs that includes the DQ that experienced the first failure. Bounded fault regions refer to a grouping of adjacent DQs that are likely to experience failures together. The separation of the memory IO into bounded fault regions of groupings of DQs allows the system to perform erasure decoding based on the DQ regions. With a reasonable number of groups, the erasure decoding can be implemented with a reasonable increase in the error correction hardware, with low latency.

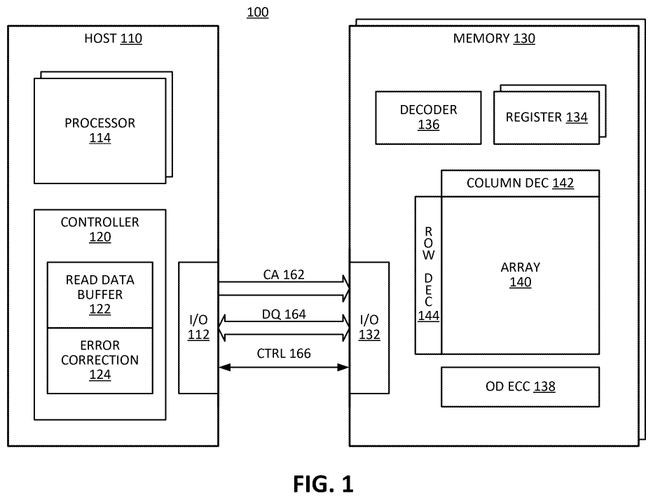

FIG. 1 is a block diagram of an example of a system that performs error correction with erasure decoding. System 100 includes host 110 with processor 114 and controller 120 coupled to memory device 130. Controller 120 represents a memory controller. In one example, controller 120 is an integrated memory controller (IMC).

System 100 includes memory device 130. In one example, memory represents memory devices in a DIMM (dual inline memory module) or other memory module. In one example, the memory module is a surface mount memory module. For example, the memory module can be a double data rate (DDR) small outline dual inline memory module (SODIMM). In one example, the surface mount DIMM has five memory dies with four data pins (DQs) per bounded fault region.

Memory device 130 includes array 140, which represents the memory array to store data. Memory device 130 includes decoder 136 to decode commands and register 134 to store configuration information. In one example, register 134 is a mode register. The configuration of register 134 controls the mode of operation of memory device 130.

Memory device 130 includes column DEC (decoder) 142 to manage access to specific columns and bits of memory. Memory device 130 includes row DEC (decoder) 144 to manage access to selected rows of memory. In one example, memory device 130 includes OD ECC (on die ECC) 138 to perform error correction on the memory die before sending the data to memory controller 120. In an example where memory device 130 includes OD ECC, the error correction circuitry (e.g., error correction 124) in host 110 can apply error correction to data from memory that has already had on die ECC applied to it.

I/O (input/output) 112 represents a hardware interface of host 110 to couple to I/O (input/output) 132 of memory device 130. The interface includes CA (command/address) 162, which represents signal lines for a command and address bus. The CA bus is a unidirectional bus from controller 120 to memory device 130.

The interface includes DQ (data) 164, which represents signal lines for a data bus. The DQ bus is a bidirectional bus allowing host 110 and memory device 130 to exchange data with each other. The interface includes control signals (CTRL) 166, which represent a management bus, such as an I3C or M3C (memory module management control) bus, or other control signals or feedback signals associated with operation of DQ 164 or CA 162. In one example, CTRL 166 represents an implementation of an IEEE 1500 interface, IEEE (Institute of Electrical and Electronics Engineers) 1500-2022, published in October 2022.

In one example, controller 120 includes RDB (read data buffer) 122 to receive data from memory device 130. Read data buffer 122 represents a read buffer that can receive and store a data word in response to a read command generated by controller 120.

In one example, controller 120 includes error correction 124 to perform error correction on the data word in the RDB received from memory device 130. In one example, error correction 124 is considered a separate circuit element from controller 120. Error correction 124 represents error correction circuitry, such as XOR (exclusive OR) gates, counters, and selection logic, to select one or more bits for error correction. At error correction 124, the data word from read data buffer 122 is a codeword for error decoding.

In one example, error correction 124 generates or calculates a syndrome based on a Reed-Solomon code. In one example, error correction 124 generates or calculates a syndrome based on a BCH (Bose-Chaudhuri-Hocquenghem) code. In one example, error correction 124 performs error correction based on erasure decoding. More specifically, error correction 124 can apply erasure decoding to correct errors when the errors are clustered in distinct regions such as separately bounded fault regions or dies.

In one example, error correction 124 applies erasure decoding to generate multiple correction candidates based on IO groupings, such as bounded fault regions or dies. Error correction 124 can select one of the correction candidates to apply error correction.

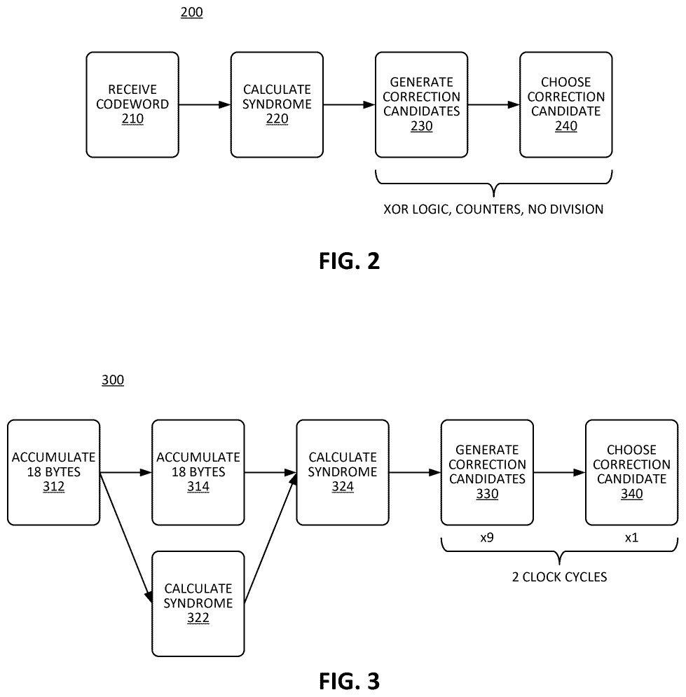

FIG. 2 is a block diagram of an example of a sequence for error correction. System 200 represents an error correction decoding in accordance with an example of system 100. System 200 does not specifically illustrate the hardware elements to perform error correction.

System 200 illustrates that the error correction hardware receives a codeword, 210, from memory, typically through a read data buffer. The host receives the codeword by reading the data word from memory (e.g., DRAM (dynamic random access memory) devices). In one example, the hardware calculates the syndrome, 220.

Whereas typical ECC decoding would involve using an algorithm (e.g., Berlekamp-Massey algorithm, Euclidean algorithm, or other algorithm) to calculate an error locator polynomial and then calculate the error evaluator polynomial, an implementation of system 200 can avoid polynomial calculations. System 200 illustrates that the hardware generates correction candidates based on erasure decoding, 230.

Typical ECC decoding would involve using an algorithm (e.g., Chien Search algorithm) to find the roots of the error locator polynomial, then perform operations (e.g., to implement Forney's equation) to calculate the error values for each symbol error, and then XOR the received codeword with the error values for each symbol error. Instead of such computationally-intensive operations, system 200 can choose the correction candidate, 240, based on erasure decoding and then XOR the selected candidate by the original data to generate the corrected data.

It will be understood that to generate correction candidates 230 and to choose a correction candidate 240, system 200 only needs XOR logic, counters, gating logic such as flip-flops, and counters. In one example, system 200 does not need hardware to perform divisions.

FIG. 3 is a block diagram of an example of an error correction sequence with a reduced overhead. System 300 represents an error correction decoding in accordance with an example of system 100. System 300 does not specifically illustrate the hardware elements to perform error correction. System 300 represents decoding in accordance with an example of system 200.

System 300 illustrates that the error correction hardware accumulates the data from the memory. In one example, the system accumulates a total of 36 bytes, accumulating the first 18 bytes, 312, and then in parallel with accumulating the second 18 bytes, 314, the system can begin calculating the syndrome, 322. The system completes calculation of the syndrome, 324, when the whole codeword is accumulated.

As with system 200, system 300 illustrates the generation of correction candidates, 330, and choosing the correction candidate, 340. System 300 illustrates a specific example where the memory devices that provide the 36 bytes of data are organized as 9 separate IO groupings. More specifically, system 300 can illustrate an example of 5 memory devices that provide 9 bounded fault regions that provide data to the host. Thus, system 300 generates 9 correction candidates and then selects 1 of those 9 correction candidates as the candidate to which error correction will be applied.

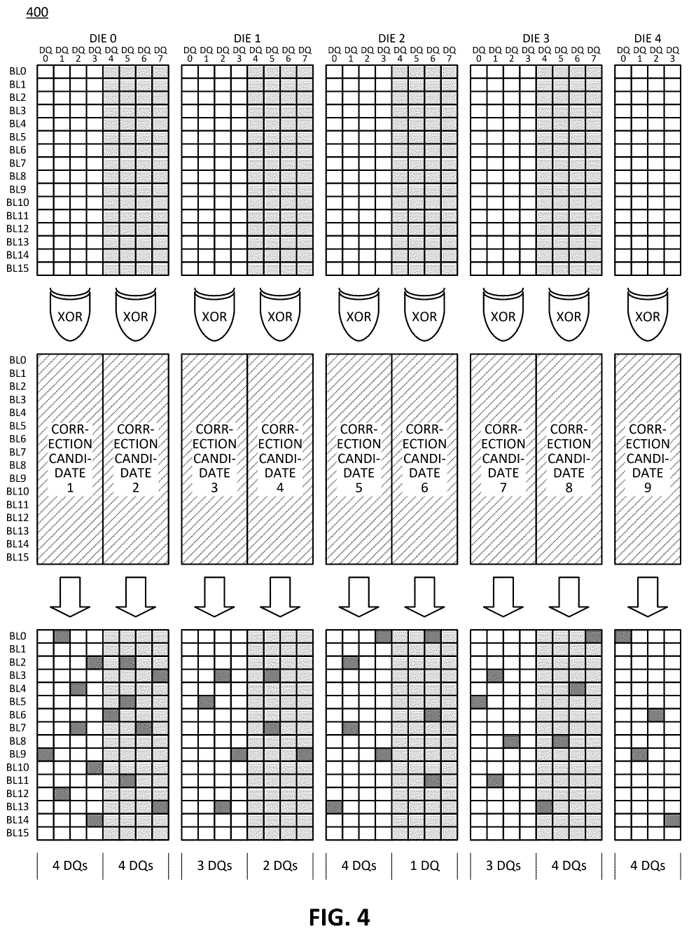

FIG. 4 is a block diagram of an example of erasure decoding by bounded region. System 400 represents a system in accordance with an example of system 100, or an example of system 200, or an example of system 300.

System 400 illustrates an example with 5 dies. Each of the 5 dies is illustrated as having 8 data interfaces, DQ[0:7]. System 400 is illustrated as having a burst length of 16, BL16, with the transfer periods indicated as BL[0:15]. The transfer periods occur sequentially in time. The dies are divided into different groups of IOs, as illustrated by the shading. More specifically, for each die, DQ[0-3] are one IO grouping as a bounded fault zone and DQ[4-7] are another IO grouping as a bounded fault zone. Die 4 only has DQ[0-3], for a total of 9 regions.

Based on bounded fault rules, it is expected that most faults will be in 2 DQ lanes within 4-DQ regions in one die. Thus, the grouping of the IOs into the bounded fault regions makes sense, both from the perspective of enabling erasure decoding, but also because the bounded fault regions are most likely to fail together.

Below the dies, system 400 illustrates XOR logic. The XOR logic generates the syndrome, which is represented by the various correction candidates, Candidate[1-9]. In one example, the computation of the candidates generates a configuration of bits in each region, which is represented by the bit mapping at the bottom of system 400. The generation of the candidates can generate regions having a number of DQs with errors.

In one example, the second half of Die 1 has 2 DQs with failures and the second half of Die 2 has 1 DQ with failures. In one example, the region with the fewest DQs with errors is the best candidate for error correction. Thus, the system can select the second half (the shaded portion) of Die 2 as the candidate for error correction.

For Reed-Solomon codes, since the minimum distance of a code with 2-symbol correction is 5, if one correction candidate has 2 symbol errors, other correction candidates should have at least 3 symbol errors, which would mean only one correction candidate will be valid. Again, it will be understood that descriptions related to Reed-Solomon symbols are not limiting. Rather, any linear code that enables erasure decoding can be used in the system. Reed-Solomon codes have some attractive properties, such as guaranteeing that there is only one valid correction candidate.

In one example, system 400 includes a syndrome generator, such as a 64×64 submatrix. The submatrix is a submatrix of a complete H matrix. In one example, the system can be implemented without syndrome generation. However, it will be understood that skipping the syndrome would require additional hardware and die space, which could be limiting for many implementations.

In one example, as illustrated in system 400, after calculation of the syndrome, the various correctable error pattern candidates can be generated by multiplying the syndrome by multiple submatrices. In one example, the submatrices are inverses of submatrices of a fixed H-matrix. In one example, the multiple submatrices are 64×64 H submatrices. In one example, the system performs error correction by performing an XOR of a selected correctable error pattern candidate by the bounded fault region of the data word, thus XORing the correction candidate by the corresponding region of the original data word.

After identifying the candidates, the system chooses one of the nine correction candidates. In one example, the correction logic compares each of the correction candidates with the original received data, to determine where the bit errors would be. In one example, a candidate that has bit errors in 1 or 2 DQ lanes is a valid correction candidate, and the system chooses this correction candidate to be part of the corrected codeword. In one example, if the bit errors are in 3 or 4 DQ lanes, the correction candidate is an invalid correction candidate, which the system ignores. If none of the correction candidates are valid, in one example, the system determines that the received codeword is uncorrectable.

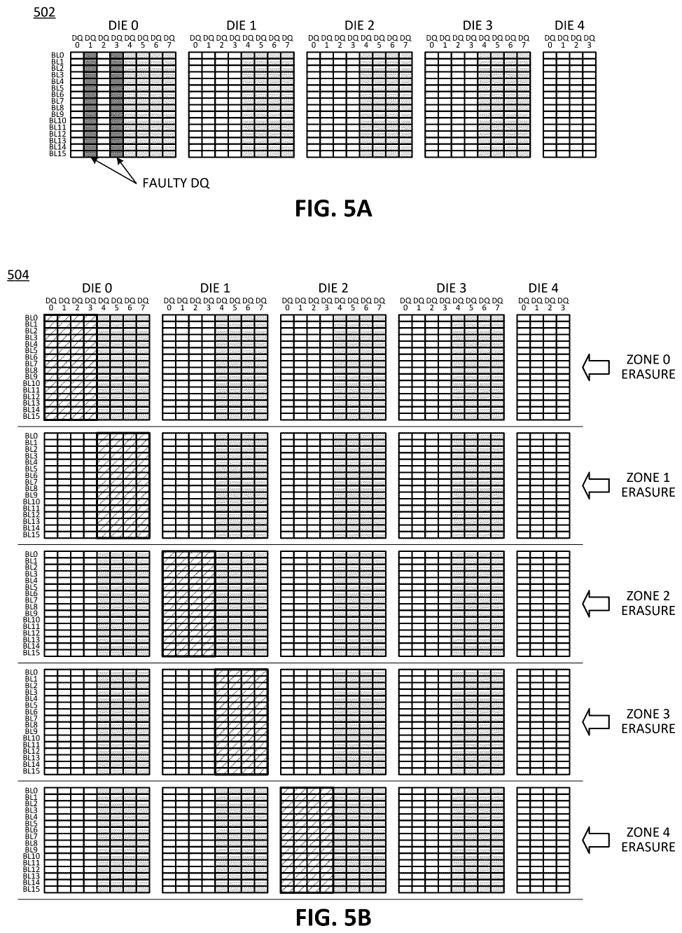

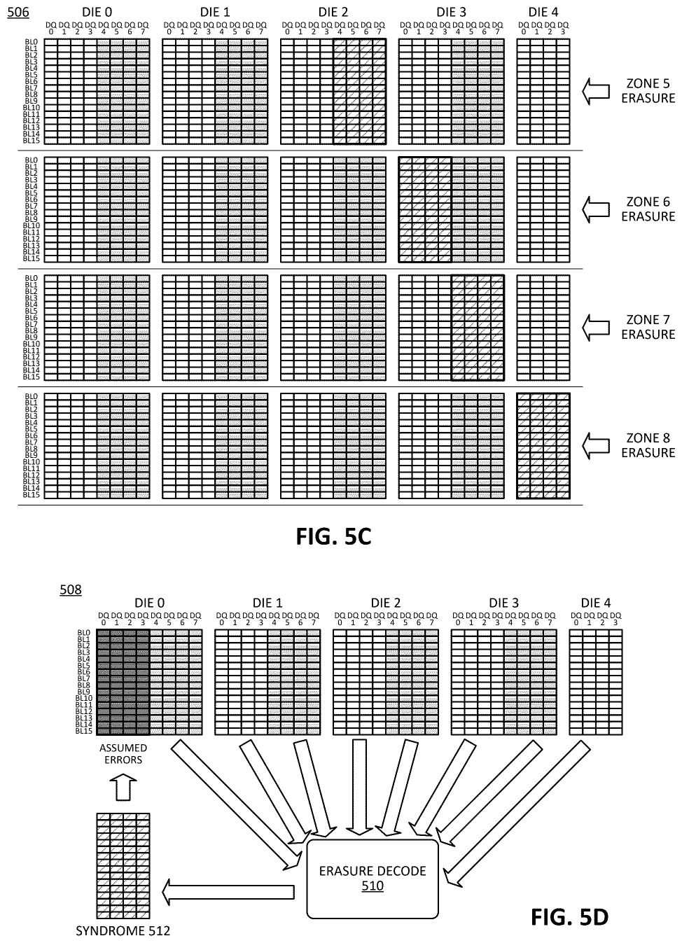

FIG. 5A is a block diagram of an example of a system that applies erasure decoding for error correction. Diagram 502 illustrates an example of 5 dies having 2 DQ faults for a system in accordance with an example of system 100, system 200, system 300, or system 400. Diagram 502 specifically illustrates errors in DQ1 and DQ3 of Die 0, which are both within the first bounded fault region of Die 0.

The example illustrates a 2 symbol error. The system can be extended to correct 4 symbol errors, as long as there are known regions where errors are all clustered together. Diagram 502 illustrates a system in which the bounded fault region is each separate group of 4 DQs. For upcoming memory standards, the memory devices may have regions with 6 DQs instead of 4 DQs. In one example, instead of counting DQs, the system could count symbols to determine whether or not a correction candidate is valid or not.

In one example, the use of erasure coding should correct errors only in bounded fault regions. If there were errors in on 2 DQ pins within the same bounded fault region, the system would correct the error. If there were errors in 2 DQ pins that are separated, meaning not in the same bounded fault region, the memory controller would detect uncorrectable errors.

FIG. 5B illustrates diagram 504 showing the application of the multiplication of the syndrome by a fixed matrix. More specifically, Zone 0 Erasure is generated by multiplying the syndrome by the matrix of DQ[0:3] of Die 0, Zone 1 Erasure is generated by multiplying the syndrome by the matrix of DQ[4:7] of Die 0, Zone 2 Erasure is generated by multiplying the syndrome by the matrix of DQ[0:3] of Die 1, Zone 3 Erasure is generated by multiplying the syndrome by the matrix of DQ[4:7] of Die 1, and Zone 4 Erasure is generated by multiplying the syndrome by the matrix of DQ[0:3] of Die 2.

FIG. 5C illustrates diagram 506 showing the application of the multiplication of the syndrome by a fixed matrix. More specifically, Zone 5 Erasure is generated by multiplying the syndrome by the matrix of DQ[4:7] of Die 2, Zone 6 Erasure is generated by multiplying the syndrome by the matrix of DQ[0:3] of Die 3, Zone 7 Erasure is generated by multiplying the syndrome by the matrix of DQ[4:7] of Die 3, and Zone 8 Erasure is generated by multiplying the syndrome by the matrix of DQ[0:3] of Die 4.

The erasure decode can be calculated by multiplying the syndrome by a fixed matrix, which is illustrated as the separate submatrices of the 9 bounded regions. Alternatively to multiplying by the submatrices, a system could multiply the received codeword directly by 9 larger matrices. However, such an approach is more expensive in terms of gate count and power. In diagrams 504 and 506, there are 9 correction candidates generated which are the highlighted portion of each of the dies.

FIG. 5D illustrates diagram 508 showing the correction of the errors of FIG. 5A based on the candidates generated in accordance with FIG. 5B and FIG. 5C. Diagram 508 illustrates that erasure decode 510 receives the syndromes for the various IO regions of the memory, and with syndrome 512 determines that the errors are located in DQ[0:3] of Die 0. Thus, the assumed errors match the errors indicated in FIG. 5A. The erasure decoding can reduce the latency of correcting the errors by bypassing the generation of polynomials.

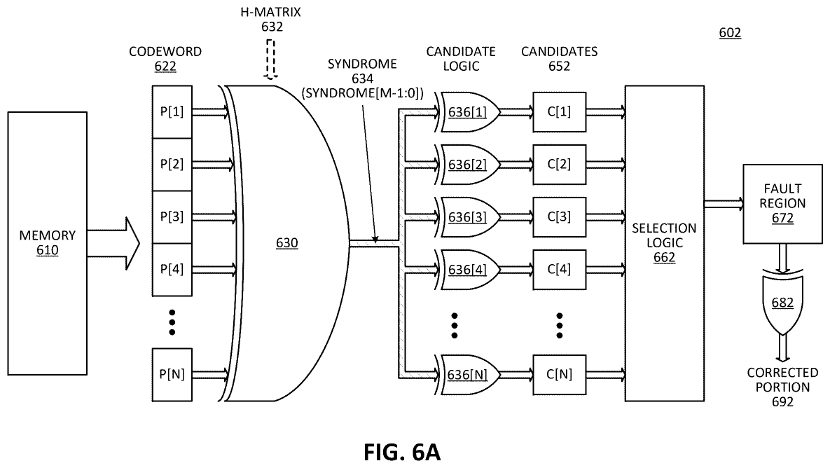

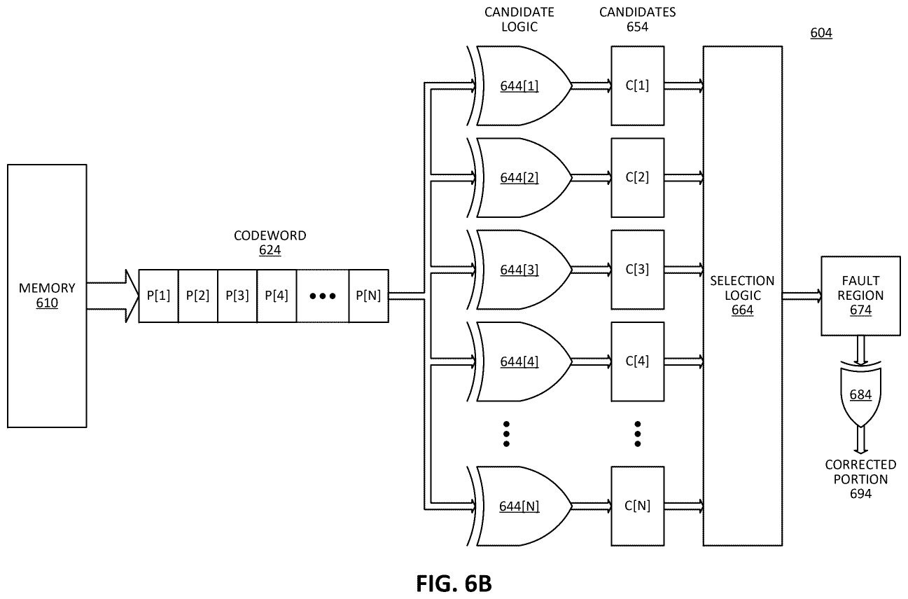

FIG. 6A is a block diagram of an example of an error decoding system. System 602 provides error decoding for a system in accordance with an example of system 100, or an example of system 200, or an example of system 300, or an example of system 400.

Memory 610 represents a memory that is read by a memory controller to access data. Memory 610 provides the data in response to a read command, and the memory controller performs ECC on the data to detect and correct errors. It will be understood that the components other than memory 610 represent error correction components of the memory controller, or of a circuit that feeds the data into the memory controller.

The error correction components represent hardware that performs erasure decoding on the received data. In one example, the hardware includes a dense array of massively parallel XORs to receive the codeword data from memory 610 and calculate the syndrome. Typically, the syndrome would be processed using a relatively small number of XOR gates to calculate a polynomial.

In system 602, in one example, the calculation of the syndrome is followed by multiple smaller, dense arrays of massively parallel XORs, whose aggregate size is similar to the first set of massively parallel XORs. The second set of XOR gates generate multiple candidates of corrected data. In one example, the hardware includes flip-flops that store candidates of corrected data instead of storing computed polynomials. System 602 can select one of the candidates of corrected data as the output data. Alternatively, if there is no error to correct, the hardware can ignore the correction candidates, such as through the application of multiplexers or equivalent logic (not explicitly illustrated).

Codeword 622 represents the data word received from memory 610. In one example, system 602 operates on codeword 622 as separate portions of data, P[1:N]. In one example, system 602 generates a syndrome for codeword 622 with XOR 630. XOR 630 represents the hardware to implement H-matrix 632, which is an H-matrix of syndrome codes for each of the data bit positions of codeword 622. It will be understood that XOR 630 is merely a representation of multiple XOR circuits, typically having one XOR circuit path per bit of the syndrome for a total of M bits of syndrome. In system 602, the entire syndrome generation (syndrome[M−1:0]) is represented by XOR 630.

In one example, system 602 XORs the syndrome (syndrome 634) from XOR 630 with XOR 636[1:N], collectively XORs 636. XORs 636 can generate candidates 652. The algorithmic configuration of XORs 636, referring to their inputs and arrangement, can be referred to as candidate logic, to generate the candidates. In one example, XORs 636 implement matrices which are inverses of 64×64 H submatrices. Candidates 652 represent the multiple individual candidates C[1:N] of correctable error patterns. The error pattern candidates can be XORed with the original data to result in corrected data, where the selected candidate XORed with the portion of the original data corresponding to the selected candidate is the corrected data.

It will be understood that as a technical matter, a true XOR operation can only exist for two inputs, where an output is one if and only if only one of the inputs is one. However, it is common convention to represent a cascade of XOR operations as a multi-input XOR (meaning a number of inputs greater than 2), such as XOR 630 and XORs 636. The XOR operation has a commutative property, and the XORing of multiple pairs of inputs, and then the series XORing of the outputs of those operations can be interchanged in any order with the same result. Thus, the XOR operations have the practical effect of modulo 2 addition, which is also equivalent to odd parity detection. Odd parity detection provides a ‘1’ as the output when there is an odd number of ones among the inputs, and an output zero when there is an even number of ones among the inputs.

Selection logic 662 represents hardware to ignore the candidates 652, meaning to bypass the outputs of the error correction hardware, in the event that data errors are not found. Selection logic 662 also represents the hardware to select one of candidates 652 as the group of IOs to use as the error pattern to apply error correction. Reference to applying error correction to the IOs can be understood as performing correction computations on the data bits received from the selected IOs. In one example, the correction computations refers to XORing the selected error pattern candidate by the original data corresponding to that candidate.

Thus, selection logic 662 indicates fault region 672, and the system can apply error correction to fault region 672 by replacing the original data with the corrected data. The output of the error correction operation(s) will add the corrected data for the selected region to the data of the other regions that were not selected as having errors. XOR 682 represents XORing the selected candidate with the corresponding portion of the original data (e.g., one of P[1:N] of codeword 622) to generate corrected portion 692.

FIG. 6B is a block diagram of an example of an error decoding system that does not first generate a syndrome. System 604 provides error decoding for a system in accordance with an example of system 100, or an example of system 200, or an example of system 300, or an example of system 400.

Memory 610 represents a memory that is read by a memory controller to access data. Memory 610 provides the data in response to a read command, and the memory controller performs ECC on the data to detect and correct errors. It will be understood that the components other than memory 610 represent error correction components of the memory controller, or of a circuit that feeds the data into the memory controller.

Codeword 624 represents the data word received from memory 610. In one example, system 604 operates on codeword 624 as separate portions of data, P[1:N]. In one example, system 604 has XOR logic XOR 644[1:N], collectively XORs 644, to generate N error correction pattern candidates 654. XORs 644 represent algorithmic logic to selectively XOR bits of codeword 624 to generate candidates for the separate IO portions of the received codeword. It will be understood that XORs 644 are each a representation of multiple XOR circuits.

The error correction components represent hardware that performs erasure decoding on the received data. In one example, the hardware includes a dense array of massively parallel XORs to receive the codeword data from memory 610 and calculate error pattern candidates. Candidates 654 represent the multiple individual candidates C[1:N] of correctable error patterns.

In system 604, in one example, the calculation of the candidates occurs through a dense array of massively parallel XORs. Instead of generating a syndrome and then generating candidates, system 604 essentially represents circuitry where the syndrome calculation is performed in the N separate paths, instead of once and then being reused for separate paths as in system 602. Essentially, system 604 provides a different implementation that provides a mathematically equivalent result to system 602.

Selection logic 664 represents hardware to ignore the candidates 654, meaning to bypass the outputs of the error correction hardware, in the event that data errors are not found. Selection logic 664 also represents the hardware to select one of candidates 654 as the group of IOs to use as the error pattern to apply error correction.

Selection logic 664 can indicate fault region 674, and the system can apply error correction to fault region 674 by replacing the original data with the corrected data. The output of the error correction operation(s) will add the corrected data for the selected region to the data of the other regions that were not selected as having errors. XOR 684 represents XORing the selected candidate with the corresponding portion of the original data (e.g., one of P[1:N] of codeword 622) to generate corrected portion 694.

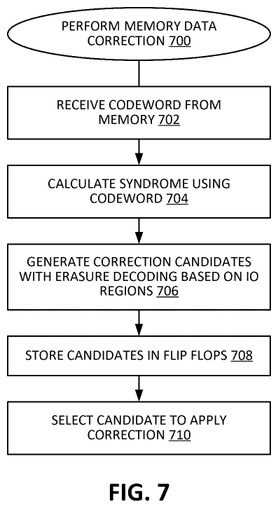

FIG. 7 is a flow diagram of an example of process for error correction. Process 700 represents a process for performing memory data correction. Process 700 can be executed by a system in accordance with an example of system 100, or an example of system 200, or an example of system 300, or an example of system 400, or an example of system 602, or an example of system 604.

The memory controller receives a codeword from memory, at 702. The memory controller can receive the data at a read data buffer and provide the data to hardware that implements the error correction.

In one example, the hardware calculates a syndrome using the received codeword, at 704. The hardware generates error pattern candidates with erasure decoding based on IO regions, at 706. An example of IO regions is the bounded fault regions of the memory devices. The regions do not have to be bounded fault regions. The regions can be individual dies, which can especially be useful for ×4 memory dies. Alternatively, the hardware can be arranged to separate the IO into some other grouping to provide regions to enable the use of erasure decoding.

In one example, the hardware stores the error pattern candidates in flip flops, at 708. Other buffers can be used in place of flip flops. In one example, the hardware selects one of the multiple candidates to which to apply error correction, at 710. The error correction can involve XORing the candidate by the original data to correct errors in the original data. In place of XORing, the hardware can perform other computations to apply error correction.

In one example, the flip flops or other buffers can be used to store candidates of corrected data, which refers to the original data, referring to the received codeword, by a generator matrix. Such corrected data candidates can have the same number of correction candidates, with a generator matrix times each separate portion of the received codeword. In such an example, the selection can refer to selecting the corrected data candidate to apply to the received codeword.

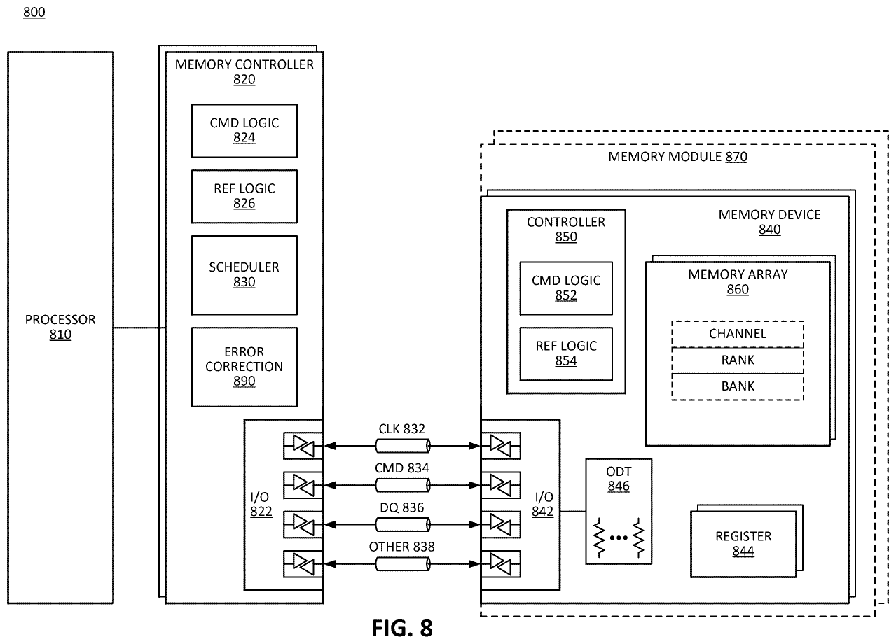

FIG. 8 is a block diagram of an example of a memory subsystem in which erasure decoding error correction can be implemented. System 800 includes a processor and elements of a memory subsystem in a computing device. System 800 represents a system in accordance with an example of system 100, system 200, system 300, system 400, or system 602, or system 604.

In one example, system 800 includes error correction 890 in memory controller 820. Error correction 890 can be in accordance with any example herein. Error correction 890 performs error correction based on erasure decoding instead of typical ECC decoding.

Processor 810 represents a processing unit of a computing platform that may execute an operating system (OS) and applications, which can collectively be referred to as the host or the user of the memory. The OS and applications execute operations that result in memory accesses. Processor 810 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or hard disk controller. Such devices can be integrated with the processor in some systems or attached to the processer via a bus (e.g., PCI express), or a combination. System 800 can be implemented as an SOC (system on a chip), or be implemented with standalone components.

Reference to memory devices can apply to different memory types. A memory device often refers to storage on a device with volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM). A memory subsystem as described herein may be compatible with a number of memory technologies, such as DDR5 (double data rate version 5, JESD79-5, originally published by JEDEC in July 2020), LPDDR5 (LPDDR version 5, JESD209-5, originally published by JEDEC in February 2019), HBM2 (high bandwidth memory version 2, JESD235C, originally published by JEDEC in January 2020), HBM3 (HBM version 3, JESD238, originally published by JEDEC in January 2022), LPDDR6 (LPDDR version 6, JESD209-6, currently in discussion by JEDEC), DDR6 (DDR version 6, JESD79-6, currently in discussion by JEDEC), or others or combinations of memory technologies, and technologies based on derivatives or extensions of such specifications.

Memory controller 820 represents one or more memory controller circuits or devices for system 800. Memory controller 820 represents control logic that generates memory access commands in response to the execution of operations by processor 810. Memory controller 820 accesses one or more memory devices 840. Memory devices 840 can be DRAM devices in accordance with any referred to above. In one example, memory devices 840 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. Coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one example, settings for each channel are controlled by separate mode registers or other register settings. In one example, each memory controller 820 manages a separate memory channel, although system 800 can be configured to have multiple channels managed by a single controller, or to have multiple controllers on a single channel. In one example, memory controller 820 is part of host processor 810, such as logic implemented on the same die or implemented in the same package space as the processor.

Memory controller 820 includes I/O interface logic 822 to couple to a memory bus, such as a memory channel as referred to above. I/O interface logic 822 (as well as I/O interface logic 842 of memory device 840) can include pins, pads, connectors, signal lines, traces, or wires, or other hardware to connect the devices, or a combination of these. I/O interface logic 822 can include a hardware interface. As illustrated, I/O interface logic 822 includes at least drivers/transceivers for signal lines. Commonly, wires within an integrated circuit interface couple with a pad, pin, or connector to interface signal lines or traces or other wires between devices. I/O interface logic 822 can include drivers, receivers, transceivers, or termination, or other circuitry or combinations of circuitry to exchange signals on the signal lines between the devices. The exchange of signals includes at least one of transmit or receive. While shown as coupling I/O 822 from memory controller 820 to I/O 842 of memory device 840, it will be understood that in an implementation of system 800 where groups of memory devices 840 are accessed in parallel, multiple memory devices can include I/O interfaces to the same interface of memory controller 820. In an implementation of system 800 including one or more memory modules 870, I/O 842 can include interface hardware of the memory module in addition to interface hardware on the memory device itself. Other memory controllers 820 will include separate interfaces to other memory devices 840.

The bus between memory controller 820 and memory devices 840 can be implemented as multiple signal lines coupling memory controller 820 to memory devices 840. The bus may typically include at least clock (CLK) 832, command/address (CMD) 834, and write data (DQ) and read data (DQ) 836, and zero or more other signal lines 838. In one example, a bus or connection between memory controller 820 and memory can be referred to as a memory bus. In one example, the memory bus is a multi-drop bus. The signal lines for CMD can be referred to as a “C/A bus” (or ADD/CMD bus, or some other designation indicating the transfer of commands (C or CMD) and address (A or ADD) information) and the signal lines for write and read DQ can be referred to as a “data bus.” In one example, independent channels have different clock signals, C/A buses, data buses, and other signal lines. Thus, system 800 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 820 and memory devices 840. An example of a serial bus technology is 8B10B encoding and transmission of high-speed data with embedded clock over a single differential pair of signals in each direction. In one example, CMD 834 represents signal lines shared in parallel with multiple memory devices. In one example, multiple memory devices share encoding command signal lines of CMD 834, and each has a separate chip select (CS_n) signal line to select individual memory devices.

It will be understood that in the example of system 800, the bus between memory controller 820 and memory devices 840 includes a subsidiary command bus CMD 834 and a subsidiary bus to carry the write and read data, DQ 836. In one example, the data bus can include bidirectional lines for read data and for write/command data. In another example, the subsidiary bus DQ 836 can include unidirectional write signal lines for write and data from the host to memory, and can include unidirectional lines for read data from the memory to the host. In accordance with the chosen memory technology and system design, other signals 838 may accompany a bus or sub bus, such as strobe lines DQS. Based on design of system 800, or implementation if a design supports multiple implementations, the data bus can have more or less bandwidth per memory device 840. For example, the data bus can support memory devices that have either a ×4 interface, a ×8 interface, a ×16 interface, or other interface. The convention “×W,” where W is an integer that refers to an interface size or width of the interface of memory device 840, which represents a number of signal lines to exchange data with memory controller 820. The interface size of the memory devices is a controlling factor on how many memory devices can be used concurrently per channel in system 800 or coupled in parallel to the same signal lines. In one example, high bandwidth memory devices, wide interface devices, or stacked memory configurations, or combinations, can enable wider interfaces, such as a ×128 interface, a ×256 interface, a ×512 interface, a ×1024 interface, or other data bus interface width.

In one example, memory devices 840 and memory controller 820 exchange data over the data bus in a burst, or a sequence of consecutive data transfers. The burst corresponds to a number of transfer cycles, which is related to a bus frequency. In one example, the transfer cycle can be a whole clock cycle for transfers occurring on a same clock or strobe signal edge (e.g., on the rising edge). In one example, every clock cycle, referring to a cycle of the system clock, is separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length eight (BL8), and each memory device 840 can transfer data on each UI. Thus, a ×8 memory device operating on BL8 can transfer 64 bits of data (8 data signal lines times 8 data bits transferred per line over the burst). It will be understood that this simple example is merely an illustration and is not limiting.

Memory devices 840 represent memory resources for system 800. In one example, each memory device 840 is a separate memory die. In one example, each memory device 840 can interface with multiple (e.g., 2) channels per device or die. Each memory device 840 includes I/O interface logic 842, which has a bandwidth determined by the implementation of the device (e.g., ×16 or ×8 or some other interface bandwidth). I/O interface logic 842 enables the memory devices to interface with memory controller 820. I/O interface logic 842 can include a hardware interface, and can be in accordance with I/O 822 of memory controller, but at the memory device end. In one example, multiple memory devices 840 are connected in parallel to the same command and data buses. In another example, multiple memory devices 840 are connected in parallel to the same command bus, and are connected to different data buses. For example, system 800 can be configured with multiple memory devices 840 coupled in parallel, with each memory device responding to a command, and accessing memory resources 860 internal to each. For a Write operation, an individual memory device 840 can write a portion of the overall data word, and for a Read operation, an individual memory device 840 can fetch a portion of the overall data word. The remaining bits of the word will be provided or received by other memory devices in parallel.

In one example, memory devices 840 are disposed directly on a motherboard or host system platform (e.g., a PCB (printed circuit board) or substrate on which processor 810 is disposed) of a computing device. In one example, memory devices 840 can be organized into memory modules 870. In one example, memory modules 870 represent dual inline memory modules (DIMMs). In one example, memory modules 870 represent other organization of multiple memory devices to share at least a portion of access or control circuitry, which can be a separate circuit, a separate device, or a separate board from the host system platform. Memory modules 870 can include multiple memory devices 840, and the memory modules can include support for multiple separate channels to the included memory devices disposed on them. In another example, memory devices 840 may be incorporated into the same package as memory controller 820, such as by techniques such as multi-chip-module (MCM), package-on-package, through-silicon via (TSV), or other techniques or combinations. Similarly, in one example, multiple memory devices 840 may be incorporated into memory modules 870, which themselves may be incorporated into the same package as memory controller 820. It will be appreciated that for these and other implementations, memory controller 820 may be part of host processor 810.

Memory devices 840 each include one or more memory arrays 860. Memory array 860 represents addressable memory locations or storage locations for data. Typically, memory array 860 is managed as rows of data, accessed via wordline (rows) and bitline (individual bits within a row) control. Memory array 860 can be organized as separate channels, ranks, and banks of memory. Channels may refer to independent control paths to storage locations within memory devices 840. Ranks may refer to common locations across multiple memory devices (e.g., same row addresses within different devices) in parallel. Banks may refer to sub-arrays of memory locations within a memory device 840. In one example, banks of memory are divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one example, memory devices 840 include one or more registers 844. Register 844 represents one or more storage devices or storage locations that provide configuration or settings for the operation of the memory device. In one example, register 844 can provide a storage location for memory device 840 to store data for access by memory controller 820 as part of a control or management operation. In one example, register 844 includes one or more Mode Registers. In one example, register 844 includes one or more multipurpose registers. The configuration of locations within register 844 can configure memory device 840 to operate in different “modes,” where command information can trigger different operations within memory device 840 based on the mode. Additionally or in the alternative, different modes can also trigger different operation from address information or other signal lines depending on the mode. Settings of register 844 can indicate configuration for I/O settings (e.g., timing, termination or ODT (on-die termination) 846, driver configuration, or other I/O settings).

In one example, memory device 840 includes ODT 846 as part of the interface hardware associated with I/O 842. ODT 846 can be configured as mentioned above, and provide settings for impedance to be applied to the interface to specified signal lines. In one example, ODT 846 is applied to DQ signal lines. In one example, ODT 846 is applied to command signal lines. In one example, ODT 846 is applied to address signal lines. In one example, ODT 846 can be applied to any combination of the preceding. The ODT settings can be changed based on whether a memory device is a selected target of an access operation or a non-target device. ODT 846 settings can affect the timing and reflections of signaling on the terminated lines. Careful control over ODT 846 can enable higher-speed operation with improved matching of applied impedance and loading. ODT 846 can be applied to specific signal lines of I/O interface 842, 822 (for example, ODT for DQ lines or ODT for CA lines), and is not necessarily applied to all signal lines.

Memory device 840 includes controller 850, which represents control logic within the memory device to control internal operations within the memory device. For example, controller 850 decodes commands sent by memory controller 820 and generates internal operations to execute or satisfy the commands. Controller 850 can be referred to as an internal controller, and is separate from memory controller 820 of the host. Controller 850 can determine what mode is selected based on register 844, and configure the internal execution of operations for access to memory resources 860 or other operations based on the selected mode. Controller 850 generates control signals to control the routing of bits within memory device 840 to provide a proper interface for the selected mode and direct a command to the proper memory locations or addresses. Controller 850 includes command logic 852, which can decode command encoding received on command and address signal lines. Thus, command logic 852 can be or include a command decoder. With command logic 852, memory device can identify commands and generate internal operations to execute requested commands.

Referring again to memory controller 820, memory controller 820 includes command (CMD) logic 824, which represents logic or circuitry to generate commands to send to memory devices 840. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 840, memory controller 820 can issue commands via I/O 822 to cause memory device 840 to execute the commands. In one example, controller 850 of memory device 840 receives and decodes command and address information received via I/O 842 from memory controller 820. Based on the received command and address information, controller 850 can control the timing of operations of the logic and circuitry within memory device 840 to execute the commands. Controller 850 is responsible for compliance with standards or specifications within memory device 840, such as timing and signaling requirements. Memory controller 820 can implement compliance with standards or specifications by access scheduling and control.

Memory controller 820 includes scheduler 830, which represents logic or circuitry to generate and order transactions to send to memory device 840. From one perspective, the primary function of memory controller 820 could be said to schedule memory access and other transactions to memory device 840. Such scheduling can include generating the transactions themselves to implement the requests for data by processor 810 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 820 typically includes logic such as scheduler 830 to allow selection and ordering of transactions to improve performance of system 800. Thus, memory controller 820 can select which of the outstanding transactions should be sent to memory device 840 in which order, which is typically achieved with logic much more complex than a simple first-in first-out algorithm. Memory controller 820 manages the transmission of the transactions to memory device 840, and manages the timing associated with the transaction. In one example, transactions have deterministic timing, which can be managed by memory controller 820 and used in determining how to schedule the transactions with scheduler 830.

In one example, memory controller 820 includes refresh (REF) logic 826. Refresh logic 826 can be used for memory resources that are volatile and need to be refreshed to retain a deterministic state. In one example, refresh logic 826 indicates a location for refresh, and a type of refresh to perform. Refresh logic 826 can trigger self-refresh within memory device 840, or execute external refreshes which can be referred to as auto refresh commands) by sending refresh commands, or a combination. In one example, controller 850 within memory device 840 includes refresh logic 854 to apply refresh within memory device 840. In one example, refresh logic 854 generates internal operations to perform refresh in accordance with an external refresh received from memory controller 820. Refresh logic 854 can determine if a refresh is directed to memory device 840, and what memory resources 860 to refresh in response to the command.

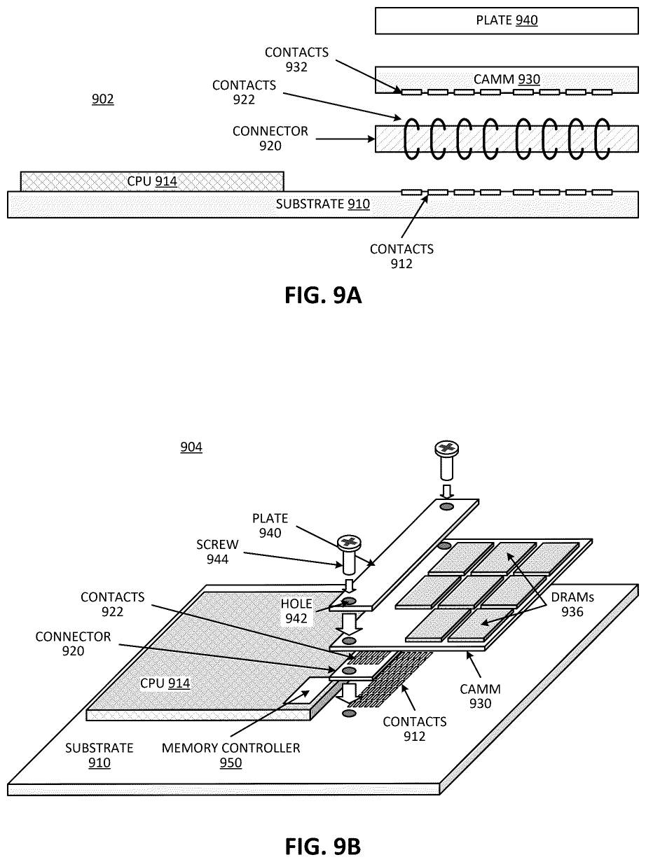

FIGS. 9A-9B are block diagrams of an example of a CAMM system in which erasure decoding error correction can be implemented.

Referring to FIG. 9A, system 1000 includes a memory stack architecture monitored by a memory fault tracker that can perform mirroring. System 902 represents a system in accordance with an example of system 100, system 200, system 300, system 400, or system 602, or system 604.

Substrate 910 illustrates an SOC package substrate or a motherboard or system board. Substrate 910 includes contacts 912, which represent contacts for connecting with memory. CPU 914 represents a CPU (processor or central processing unit) chip or GPU (graphics processing unit) chip to be disposed on substrate 910. CPU 914 performs the computational operations in system 902. In one example, CPU 914 includes multiple cores (not specifically shown), which can generate operations that request data to be read from and written to memory. CPU 914 can include a memory controller to manage access to the memory devices.

CAMM (compression-attached memory module) 930 represents a module with memory devices, which are not specifically illustrated in system 902. Substrate 910 couples to CAMM 930 and its memory devices through CMT (compression mount technology) connector 920. Connector 920 includes contacts 922, which are compression-based contacts. The compression-based contacts are compressible pins or devices whose shape compresses with the application of pressure on connector 920. In one example, contacts 922 represent C-shaped pins as illustrated. In one example, contacts 922 represent another compressible pin shape, such as a spring-shape, an S-shape, or pins having other shapes that can be compressed.

CAMM 930 includes contacts 932 on a side of the CAMM board that interfaces with connector 920. Contacts 932 connect to memory devices on the CAMM board. Plate 940 represents a plate or housing that provides structure to apply pressure to compress contacts 922 of connector 920.

Referring to FIG. 9B, system 904 is a perspective view of a system in accordance with system 902. In one example, memory controller 950 includes error correction hardware in accordance with any example herein. The error correction hardware of memory controller 950 performs error correction based on erasure decoding instead of typical ECC decoding.

CAMM 930 is illustrated with memory chips or memory dies, identified as DRAMs 936 on one or both faces of the PCB of CAMM 930. DRAMs 936 are coupled with conductive contacts via conductive traces in or on the PCB, which couples with contacts 932, which in turn couple with contacts 922 of connector 920.

System 904 illustrates holes 942 in plate 940 to receive fasteners, represented by screws 944. There are corresponding holes through CAMM 930, connector 920, and in substrate 910. Screws 944 can compressibly attach the CAMM 930 to substrate 910 via connector 920.

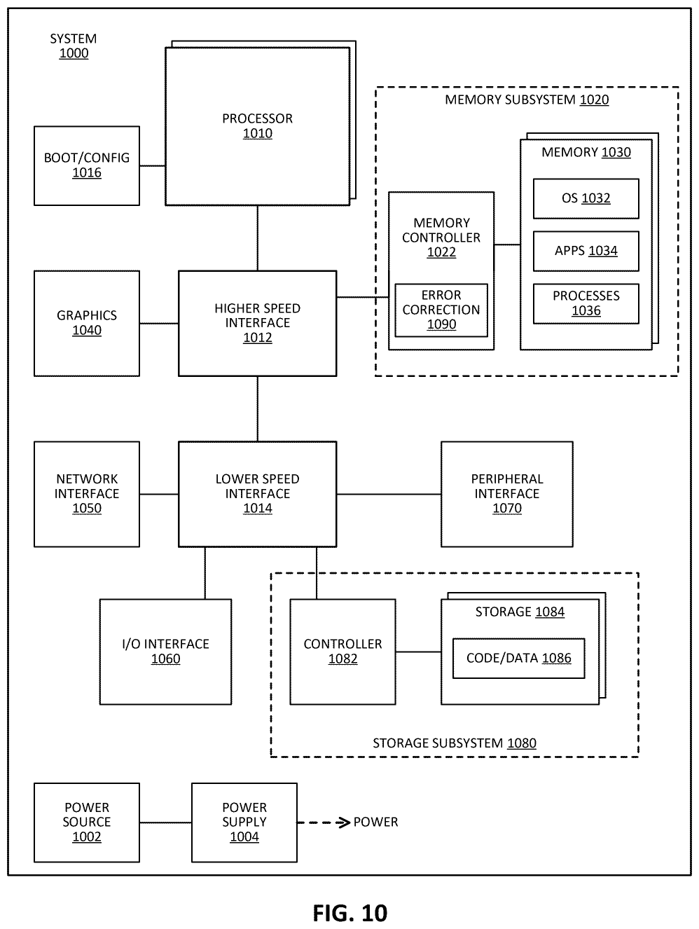

FIG. 10 is a block diagram of an example of a computing system in which erasure decoding error correction can be implemented. System 1000 represents a computing device in accordance with any example herein, and can be a laptop computer, a desktop computer, a tablet computer, a server, a gaming or entertainment control system, embedded computing device, or other electronic device.

System 1000 represents a system in accordance with an example of system 100, system 200, system 300, system 400, or system 602, or system 604. In one example, system 1000 includes error correction 1090 in memory controller 1022. Error correction 1090 can be in accordance with any example herein. Error correction 1090 performs error correction based on erasure decoding instead of typical ECC decoding.

System 1000 includes processor 1010 can include any type of microprocessor, CPU (central processing unit), GPU (graphics processing unit), processing core, or other processing hardware, or a combination, to provide processing or execution of instructions for system 1000. Processor 1010 can be a host processor device. Processor 1010 controls the overall operation of system 1000, and can be or include, one or more programmable general-purpose or special-purpose microprocessors, DSPs (digital signal processors), programmable controllers, ASICs (application specific integrated circuits), PLDs (programmable logic devices), or a combination of such devices.

System 1000 includes boot/config 1016, which represents storage to store boot code (e.g., BIOS (basic input/output system)), configuration settings, security hardware (e.g., TPM (trusted platform module)), or other system level hardware that operates outside of a host OS. Boot/config 1016 can include a nonvolatile storage device, such as ROM (read-only memory), flash memory, or other memory devices.

In one example, system 1000 includes interface 1012 coupled to processor 1010, which can represent a higher speed interface or a high throughput interface for system components that need higher bandwidth connections, such as memory subsystem 1020 or graphics interface components 1040. Interface 1012 represents an interface circuit, which can be a standalone component or integrated onto a processor die. Interface 1012 can be integrated as a circuit onto the processor die or integrated as a component on a system on a chip. Where present, graphics interface 1040 interfaces to graphics components for providing a visual display to a user of system 1000. Graphics interface 1040 can be a standalone component or integrated onto the processor die or system on a chip. In one example, graphics interface 1040 can drive a display with high definition that provides an output to a user. In one example, the display can include a touchscreen display. In one example, graphics interface 1040 generates a display based on data stored in memory 1030 or based on operations executed by processor 1010 or both.

Memory subsystem 1020 represents the main memory of system 1000, and provides storage for code to be executed by processor 1010, or data values to be used in executing a routine. Memory subsystem 1020 can include one or more varieties of RAM (random-access memory) such as DRAM, 3DXP (three-dimensional crosspoint), or other memory devices, or a combination of such devices. Memory 1030 stores and hosts, among other things, OS (operating system) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010, such as integrated onto the processor die or a system on a chip.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a PCI (peripheral component interconnect) bus, a USB (universal serial bus), or other bus, or a combination.

In one example, system 1000 includes interface 1014, which can be coupled to interface 1012. Interface 1014 can be a lower speed interface than interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can exchange data with a remote device, which can include sending data stored in memory or receiving data to be stored in memory.

In one example, system 1000 includes one or more I/O (input/output) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, NAND, 3DXP, or optical based disks, or a combination. Storage 1084 holds code or instructions and data 1086 in a persistent state (i.e., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (i.e., the value or state of the data is indeterminate if power is interrupted to system 1000). In one example, storage subsystem 1080 includes controller 1082 to interface with storage 1084. In one example controller 1082 is a physical part of interface 1014 or processor 1010, or can include circuits or logic in both processor 1010 and interface 1014.

Power source 1002 provides power to the components of system 1000. More specifically, power source 1002 typically interfaces to one or multiple power supplies 1004 in system 1000 to provide power to the components of system 1000. In one example, power supply 1004 includes an AC to DC (alternating current to direct current) adapter to plug into a wall outlet. Such AC power can be renewable energy (e.g., solar power) power source 1002. In one example, power source 1002 includes a DC power source, such as an external AC to DC converter. In one example, power source 1002 or power supply 1004 includes wireless charging hardware to charge via proximity to a charging field. In one example, power source 1002 can include an internal battery or fuel cell source.

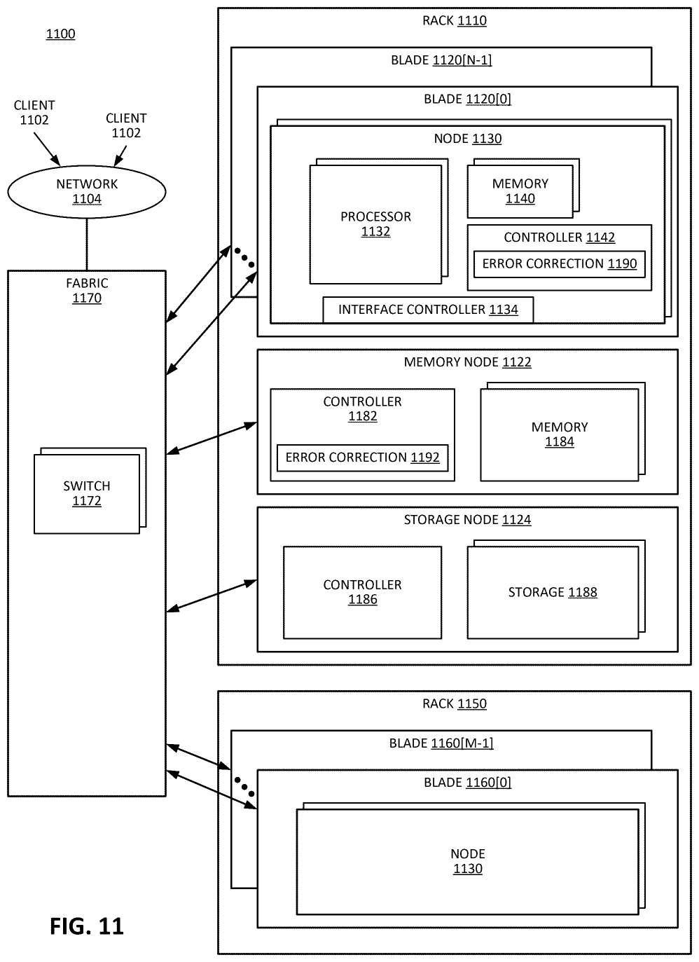

FIG. 11 is a block diagram of an example of a multi-node network in which erasure decoding error correction can be implemented. In one example, system 1100 represents a data center. In one example, system 1100 represents a server farm. In one example, system 1100 represents a data cloud or a processing cloud.

Nodes 1130 of system 1100 represent a system in accordance with an example of system 100, system 200, system 300, system 400, or system 602, or system 604. In one example, system 1100 includes error correction in the memory controllers, such as error correction 1190 in controller 1142 and error correction 1192 in controller 1182. Error correction can be in accordance with any example herein. Error correction performs error correction based on erasure decoding instead of typical ECC decoding.

One or more clients 1102 make requests over network 1104 to system 1100. Network 1104 represents one or more local networks, or wide area networks, or a combination. Clients 1102 can be human or machine clients, which generate requests for the execution of operations by system 1100. System 1100 executes applications or data computation tasks requested by clients 1102.

In one example, system 1100 includes one or more racks, which represent structural and interconnect resources to house and interconnect multiple computation nodes. In one example, rack 1110 includes multiple nodes 1130. In one example, rack 1110 hosts multiple blade components, blade 1120[0], . . . , blade 1120[N−1], collectively blades 1120. Hosting refers to providing power, structural or mechanical support, and interconnection. Blades 1120 can refer to computing resources on printed circuit boards (PCBs), where a PCB houses the hardware components for one or more nodes 1130. In one example, blades 1120 do not include a chassis or housing or other “box” other than that provided by rack 1110. In one example, blades 1120 include housing with exposed connector to connect into rack 1110. In one example, system 1100 does not include rack 1110, and each blade 1120 includes a chassis or housing that can stack or otherwise reside in close proximity to other blades and allow interconnection of nodes 1130.

System 1100 includes fabric 1170, which represents one or more interconnectors for nodes 1130. In one example, fabric 1170 includes multiple switches 1172 or routers or other hardware to route signals among nodes 1130. Additionally, fabric 1170 can couple system 1100 to network 1104 for access by clients 1102. In addition to routing equipment, fabric 1170 can be considered to include the cables or ports or other hardware equipment to couple nodes 1130 together. In one example, fabric 1170 has one or more associated protocols to manage the routing of signals through system 1100. In one example, the protocol or protocols is at least partly dependent on the hardware equipment used in system 1100.

As illustrated, rack 1110 includes N blades 1120. In one example, in addition to rack 1110, system 1100 includes rack 1150. As illustrated, rack 1150 includes M blade components, blade 1160[0], . . . , blade 1160[M−1], collectively blades 1160. M is not necessarily the same as N; thus, it will be understood that various different hardware equipment components could be used, and coupled together into system 1100 over fabric 1170. Blades 1160 can be the same or similar to blades 1120. Nodes 1130 can be any type of node and are not necessarily all the same type of node. System 1100 is not limited to being homogenous, nor is it limited to not being homogenous.

The nodes in system 1100 can include compute nodes, memory nodes, storage nodes, accelerator nodes, or other nodes. Rack 1110 is represented with memory node 1122 and storage node 1124, which represent shared system memory resources, and shared persistent storage, respectively. One or more nodes of rack 1150 can be a memory node or a storage node.

Nodes 1130 represent examples of compute nodes. For simplicity, only the compute node in blade 1120[0] is illustrated in detail. However, other nodes in system 1100 can be the same or similar. At least some nodes 1130 are computation nodes, with processor (proc) 1132 and memory 1140. A computation node refers to a node with processing resources (e.g., one or more processors) that executes an operating system and can receive and process one or more tasks. In one example, at least some nodes 1130 are server nodes with a server as processing resources represented by processor 1132 and memory 1140.

Memory node 1122 represents an example of a memory node, with system memory external to the compute nodes. Memory nodes can include controller 1182, which represents a processor on the node to manage access to the memory. The memory nodes include memory 1184 as memory resources to be shared among multiple compute nodes.

Storage node 1124 represents an example of a storage server, which refers to a node with more storage resources than a computation node, and rather than having processors for the execution of tasks, a storage server includes processing resources to manage access to the storage nodes within the storage server. Storage nodes can include controller 1186 to manage access to the storage 1188 of the storage node.

In one example, node 1130 includes interface controller 1134, which represents logic to control access by node 1130 to fabric 1170. The logic can include hardware resources to interconnect to the physical interconnection hardware. The logic can include software or firmware logic to manage the interconnection. In one example, interface controller 1134 is or includes a host fabric interface, which can be a fabric interface in accordance with any example described herein. The interface controllers for memory node 1122 and storage node 1124 are not explicitly shown.

Processor 1132 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 1140 can be or include memory devices represented by memory 1140 and a memory controller represented by controller 1142.

In general with respect to the descriptions herein, in one aspect, a memory controller includes: a read buffer to receive a data word from memory; and error correction circuitry to calculate a syndrome using the data word, generate multiple correctable error pattern candidates for the data word based on erasure decoding, with a correctable error pattern candidate per IO (input/output) region, and select one correctable error pattern candidate of the multiple correctable error pattern candidates to apply error correction.

In accordance with an example of the memory controller, to calculate the syndrome comprises generating the syndrome based on a Reed-Solomon code. In accordance with any preceding example of the memory controller, in one example, to calculate the syndrome comprises generating the syndrome based on a BCH (Bose-Chaudhuri-Hocquenghem) code. In accordance with any preceding example of the memory controller, in one example, to generate the multiple correctable error pattern candidates comprises multiplying the syndrome by multiple submatrices. In accordance with any preceding example of the memory controller, in one example, the multiple submatrices comprise inverses of H-submatrices. In accordance with any preceding example of the memory controller, in one example, to generate the multiple correctable error pattern candidates comprises generating the multiple correctable error pattern candidates without performing a polynomial computation. In accordance with any preceding example of the memory controller, in one example, to apply error correction comprises performing an XOR (exclusive OR) of the selected correctable error pattern candidate with the IO region of the data word. In accordance with any preceding example of the memory controller, in one example, the IO regions comprise bounded fault regions for memory devices of the memory. In accordance with any preceding example of the memory controller, in one example, the bounded fault regions comprise separate groups of data pins (DQs). In accordance with any preceding example of the memory controller, in one example, the memory comprises a double data rate (DDR) small outline dual inline memory module (SODIMM) having five memory dies with four data pins (DQs) per bounded fault region.

In general with respect to the descriptions herein, in one aspect, a computer system includes: a dual inline memory module (DIMM) having multiple memory devices; and a memory controller coupled to the DIMM, the memory controller including a read buffer to receive a data word from the memory devices; and error correction circuitry to calculate a syndrome using the data word, generate multiple correctable error pattern candidates for the data word based on erasure decoding, with a correctable error pattern candidate per IO (input/output) region, and select one correctable error pattern candidate of the multiple correctable error pattern candidates to apply error correction.

In accordance with one example of the computer system, to calculate the syndrome comprises generating the syndrome based on a Reed-Solomon code. In accordance with any preceding example of the computer system, in one example, to calculate the syndrome comprises generating the syndrome based on a BCH (Bose-Chaudhuri-Hocquenghem) code. In accordance with any preceding example of the computer system, in one example, to generate the multiple correctable error pattern candidates comprises multiplying the syndrome by multiple submatrices, wherein the multiple submatrices comprise inverses of H-submatrices. In accordance with any preceding example of the computer system, in one example, to generate the multiple correctable error pattern candidates comprises generating the multiple correctable error pattern candidates without performing a polynomial computation. In accordance with any preceding example of the computer system, in one example, to apply error correction comprises performing an XOR (exclusive OR) of the selected correctable error pattern candidate with the IO region of the data word. In accordance with any preceding example of the computer system, in one example, the IO regions comprise bounded fault regions for the multiple memory devices. In accordance with any preceding example of the computer system, in one example, the bounded fault regions comprise separate groups of data pins (DQs). In accordance with any preceding example of the computer system, in one example, the DIMM comprises a double data rate (DDR) small outline dual inline memory module (SODIMM) having five memory dies with four data pins (DQs) per bounded fault region. In accordance with any preceding example of the computer system, in one example, the computer system includes a host processor device coupled to the memory controller. In accordance with any preceding example of the computer system, in one example, the computer system includes display communicatively coupled to a host processor. In accordance with any preceding example of the computer system, in one example, the computer system includes network interface communicatively coupled to a host processor. In accordance with any preceding example of the computer system, in one example, the computer system includes a battery to power the computer system.

A method for error correction includes: receiving a data word from memory at a read buffer; calculating a syndrome using the data word; generating multiple correctable error pattern candidates for the data word based on erasure decoding, with a correctable error pattern candidate per IO (input/output) region; and selecting one correctable error pattern candidate of the multiple correctable error pattern candidates to apply error correction.

In accordance with one example of the method, calculating the syndrome comprises generating the syndrome based on a Reed-Solomon code. In accordance with any preceding example of the method, in one example, calculating the syndrome comprises generating the syndrome based on a BCH (Bose-Chaudhuri-Hocquenghem) code. In accordance with any preceding example of the method, in one example, generating the multiple correctable error pattern candidates comprises multiplying the syndrome by multiple submatrices. In accordance with any preceding example of the method, in one example, the multiple submatrices comprise inverses of H-submatrices. In accordance with any preceding example of the method, in one example, generating the multiple correctable error pattern candidates comprises generating the multiple correctable error pattern candidates without performing a polynomial computation. In accordance with any preceding example of the method, in one example, applying error correction comprises performing an XOR (exclusive OR) of the selected correctable error pattern candidate with the IO region of the data word. In accordance with any preceding example of the method, in one example, the IO regions comprise bounded fault regions for memory devices of the memory. In accordance with any preceding example of the method, in one example, the bounded fault regions comprise separate groups of data pins (DQs). In accordance with any preceding example of the method, in one example, the memory comprises a double data rate (DDR) small outline dual inline memory module (SODIMM) having five memory dies with four data pins (DQs) per bounded fault region.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A memory controller comprising:
a read buffer to receive a data word from memory; and
error correction circuitry to calculate a syndrome using the data word, generate multiple correctable error pattern candidates for the data word based on erasure decoding, with a correctable error pattern candidate per IO (input/output) region, and select one correctable error pattern candidate of the multiple correctable error pattern candidates to apply error correction.

2. The memory controller of claim 1, wherein to calculate the syndrome comprises generating the syndrome based on a Reed-Solomon code.

3. The memory controller of claim 1, wherein to calculate the syndrome comprises generating the syndrome based on a BCH (Bose-Chaudhuri-Hocquenghem) code.

4. The memory controller of claim 1, wherein to generate the multiple correctable error pattern candidates comprises multiplying the syndrome by multiple submatrices.

5. The memory controller of claim 4, wherein the multiple submatrices comprise inverses of H-submatrices.

6. The memory controller of claim 1, wherein to generate the multiple correctable error pattern candidates comprises generating the multiple correctable error pattern candidates without performing a polynomial computation.

7. The memory controller of claim 1, wherein to apply error correction comprises performing an XOR (exclusive OR) of the selected correctable error pattern candidate with the IO region of the data word.

8. The memory controller of claim 1, wherein the IO regions comprise bounded fault regions for memory devices of the memory.

9. The memory controller of claim 8, wherein the bounded fault regions comprise separate groups of data pins (DQs).

10. The memory controller of claim 8, wherein the memory comprises a double data rate (DDR) small outline dual inline memory module (SODIMM) having five memory dies with four data pins (DQs) per bounded fault region.

11. A computer system comprising:
a dual inline memory module (DIMM) having multiple memory devices; and
a memory controller coupled to the DIMM, the memory controller including
a read buffer to receive a data word from the memory devices; and
error correction circuitry to calculate a syndrome using the data word, generate multiple correctable error pattern candidates for the data word based on erasure decoding, with a correctable error pattern candidate per IO (input/output) region, and select one correctable error pattern candidate of the multiple correctable error pattern candidates to apply error correction.

12. The computer system of claim 11, wherein to calculate the syndrome comprises generating the syndrome based on a Reed-Solomon code.

13. The computer system of claim 11, wherein to calculate the syndrome comprises generating the syndrome based on a BCH (Bose-Chaudhuri-Hocquenghem) code.

14. The computer system of claim 11, wherein to generate the multiple correctable error pattern candidates comprises multiplying the syndrome by multiple submatrices, wherein the multiple submatrices comprise inverses of H-submatrices.

15. The computer system of claim 11, wherein to generate the multiple correctable error pattern candidates comprises generating the multiple correctable error pattern candidates without performing a polynomial computation.

16. The computer system of claim 11, wherein to apply error correction comprises performing an XOR (exclusive OR) of the selected correctable error pattern candidate with the IO region of the data word.

17. The computer system of claim 11, wherein the IO regions comprise bounded fault regions for the multiple memory devices.

18. The computer system of claim 17, wherein the bounded fault regions comprise separate groups of data pins (DQs).

19. The computer system of claim 17, wherein the DIMM comprises a double data rate (DDR) small outline dual inline memory module (SODIMM) having five memory dies with four data pins (DQs) per bounded fault region.

20. The computer system of claim 11, further comprising one or more of:
a host processor device coupled to the memory controller;
a display communicatively coupled to a host processor;
a network interface communicatively coupled to a host processor; or
a battery to power the computer system.
